(19) United States
(12) Patent Application Publication
(10) Pub. No.: US 2025/0117187 A1
(43) Pub. Date: Apr. 10, 2025

(54) COMPUTING CIRCUIT, PARTIAL SUM REGISTER, AND COMPUTING METHOD

(71) Applicant: Taiwan Semiconductor Manufacturing Company, Ltd., Hsinchu (TW)

(72) Inventors: Win-San Khwa, Taipei City (TW); Yi-Lun Lu, New Taipei City (TW); Jen-Chieh Liu, Hsinchu (TW); Jui-Jen Wu, Hsinchu (TW); Meng-Fan Chang, Taichung City (TW)

(73) Assignee: Taiwan Semiconductor Manufacturing Company, Ltd., Hsinchu (TW)

(21) Appl. No.: 18/480,521

(22) Filed: Oct. 4, 2023

(51) Int. Cl. G06F 7/544

(52) U.S. Cl. CPC G06F 7/5443

(57) ABSTRACT

A computing circuit is configured to perform a bit-serial multiplication of an input signal and a weight signal. A multiplier circuit is configured to receive the input signal and the weight signal and to provide a product sum. An adder circuit is configured to receive the product sum and to provide a partial sum. A partial sum register is configured to: clock-gate a second part of the partial sum register; receive the partial sum; provide, based on the partial sum, a first output of the bit-serial multiplication through a first part of the partial sum register; determine whether not to clock-gate the second part of the partial sum register or not based on a first feature bit of the partial sum; and provide, based on the first feature bit of the partial sum, a second output of the bit-serial multiplication through the second part of the partial sum register.

### BACKGROUND

### Technical Field

The disclosure relates to a computing circuit; particularly, the disclosure relates to a computing circuit, a partial sum register, and a computing method.

### Description of Related Art

Compute-in-memory (CIM) or in-memory computing systems store information in the main random-access memory (RAM) of computers and perform calculations at memory cell level, rather than moving large quantities of data between the main RAM and data store for each computation step. Because stored data is accessed much more quickly when it is stored in RAM, compute-in-memory allows data to be analyzed in real time, enabling faster reporting and decision-making in business and machine learning applications. Efforts are ongoing to improve the performance of compute-in-memory systems.

### SUMMARY

The disclosure is direct to a computing circuit, a partial sum register, and a computing method, so as to reduce the power consumption.

In this disclosure, a computing circuit is provided. The computing circuit is configured to perform a bit-serial multiplication of an input signal and a weight signal. A multiplier circuit is configured to receive the input signal and the weight signal and to provide a product sum. An adder circuit is configured to receive the product sum and to provide a partial sum. A partial sum register is configured to: clock-gate a second part of the partial sum register; receive the partial sum; provide, based on the partial sum, a first output of the bit-serial multiplication through a first part of the partial sum register; determine whether not to clock-gate the second part of the partial sum register or not based on a first feature bit of the partial sum; and provide, based on the first feature bit of the partial sum, a second output of the bit-serial multiplication through the second part of the partial sum register.

In this disclosure, a partial sum register is provided. The partial sum register is configured to: clock-gate a second part circuit of the partial sum register; receive a partial sum of a bit-serial multiplication of an input signal and a weight signal; provide, based on the partial sum, a first output of the bit-serial multiplication through a first part circuit of the partial sum register; determine whether not to clock-gate the second part circuit of the partial sum register or not based on a first feature bit of the partial sum; and provide, based on the first feature bit of the partial sum, a second output of the bit-serial multiplication through the second part circuit of the partial sum register.

In this disclosure, a computing method is provided. The computing method includes: clock-gating a second part circuit of a partial sum register; receiving a partial sum of a bit-serial multiplication of an input signal and a weight signal; providing, based on the partial sum, a first output of the bit-serial multiplication through a first part circuit of the partial sum register; determining whether not to clock-gate the second part circuit of the partial sum register or not based on a first feature bit of the partial sum; and providing, based on the first feature bit of the partial sum, a second output of the bit-serial multiplication through the second part circuit of the partial sum register.

Based on the above, according to the computing circuit, the partial sum register, and the computing method, the energy consumption of each computation may be reduced, thereby reducing a significant amount of energy of a training of a neural network.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of a computing circuit according to an embodiment of the disclosure.

FIG. 2A is a schematic diagram of a bit-serial multiplication according to an embodiment of the disclosure.

FIG. 2B is a schematic diagram of a bit-serial multiplication according to an embodiment of the disclosure.

FIG. 3A is a schematic diagram of a computing scenario of a bit-serial multiplication according to an embodiment of the disclosure.

FIG. 3B is a schematic diagram of a computing scenario of a bit-serial multiplication according to an embodiment of the disclosure.

FIG. 3C is a schematic diagram of a computing scenario of a bit-serial multiplication according to an embodiment of the disclosure.

FIG. 3D is a schematic diagram of a computing scenario of a bit-serial multiplication according to an embodiment of the disclosure.

FIG. 4 is a schematic diagram of a partial sum register according to an embodiment of the disclosure.

FIG. 5A is a schematic diagram of a circuit structure of a partial sum register according to an embodiment of the disclosure.

FIG. 5B is a schematic diagram of a circuit structure of a partial sum register according to an embodiment of the disclosure.

FIG. 6A is a schematic diagram of a circuit structure of a partial sum register according to an embodiment of the disclosure.

FIG. 6B is a schematic diagram of a circuit structure of a partial sum register according to an embodiment of the disclosure.

FIG. 6C is a schematic diagram of a timing chart of partial sum register according to an embodiment of the disclosure.

FIG. 7 is a schematic flowchart of a computing method according to an embodiment of the disclosure.

### DESCRIPTION OF THE EMBODIMENTS

Reference will now be made in detail to the exemplary embodiments of the disclosure, examples of which are illustrated in the accompanying drawings. Whenever possible, the same reference numbers are used in the drawings and the description to refer to the same or like components.

Certain terms are used throughout the specification and appended claims of the disclosure to refer to specific components. Those skilled in the art should understand that electronic device manufacturers may refer to the same components by different names. This article does not intend to distinguish those components with the same function but different names. In the following description and rights request, the words such as “comprise” and “include” are open-ended terms, and should be explained as “including but not limited to . . . ”.

The term “coupling (or connection)” used throughout the whole specification of the present application (including the appended claims) may refer to any direct or indirect connection means. For example, if the text describes that a first device is coupled (or connected) to a second device, it should be interpreted that the first device may be directly connected to the second device, or the first device may be indirectly connected through other devices or certain connection means to be connected to the second device. The terms “first”, “second”, and similar terms mentioned throughout the whole specification of the present application (including the appended claims) are merely used to name discrete elements or to differentiate among different embodiments or ranges. Therefore, the terms should not be regarded as limiting an upper limit or a lower limit of the quantity of the elements and should not be used to limit the arrangement sequence of elements. In addition, wherever possible, elements/components/steps using the same reference numerals in the drawings and the embodiments represent the same or similar parts. Reference may be mutually made to related descriptions of elements/components/steps using the same reference numerals or using the same terms in different embodiments.

It should be noted that in the following embodiments, the technical features of several different embodiments may be replaced, recombined, and mixed without departing from the spirit of the disclosure to complete other embodiments. As long as the features of each embodiment do not violate the spirit of the disclosure or conflict with each other, they may be mixed and used together arbitrarily.

Compute-in-memory (CIM) or in-memory computing systems store information in the main random-access memory (RAM) of computers and perform calculations at memory cell level, rather than moving large quantities of data between the main RAM and data store for each computation step. Because stored data is accessed much more quickly when it is stored in RAM, compute-in-memory allows data to be analyzed in real time, enabling faster reporting and decision-making in business and machine learning applications. Efforts are ongoing to improve the performance of compute-in-memory systems.

An example of applications of CIM is multiply-accumulate (MAC) operations. Computer artificial intelligence (AI) uses deep learning techniques, where a computing system may be organized as a neural network. A neural network refers to a plurality of interconnected processing nodes that enable the analysis of data, for example. Neural networks compute the product-sum between “input” and “weights” vectors. Neural networks use multiple layers of computational nodes, where deeper layers perform computations based on results of computations performed by higher layers.

In one embodiment, a CIM device includes a memory array with memory cells arranged in rows and columns. The memory cells are configured to store weight signals, and an input driver provides input signals. A multiply and accumulation (or multiplier-accumulator) circuit performs MAC operations, where each MAC operation computes a product of two numbers and adds that product to an accumulator (or adder). In some embodiments, a processing device or a dedicated MAC unit or device may contain MAC computational hardware logic that includes a multiplier implemented in combinational logic followed by an adder and an accumulator that stores the result. The output of the accumulator may be fed back to an input of the adder, so that on each clock cycle, the output of the multiplier is added to the accumulator. Example processing devices include, but are not limited to, a microprocessor, a digital signal processor (DSP), an application-specific integrated circuit (ASIC), a field programmable gate array (FPGA), programmable logic device (PLD), and microprocessor control unit (MCU).

Machine learning (ML) involves computer algorithms that may improve automatically through experience and by the use of data. It is seen as a part of artificial intelligence. Machine learning algorithms build a model based on sample data, known as “training data” in order to make predictions or decisions without being explicitly programmed to do so.

Neural networks may include a plurality of interconnected processing nodes that enable the analysis of data to compare an input to such “trained” data. Trained data refers to computational analysis of properties of known data to develop models to use to compare input data. An example of an application of AI and data training is found in object recognition, where a system analyzes the properties of many (e.g., thousands or more) of images to determine patterns that can be used to perform statistical analysis to identify an input object.

As noted above, neural networks compute the product-sum between “input” and “weights” vectors. Neural networks use multiple layers of computational nodes, where deeper layers perform computations based on results of computations performed by higher layers. Machine learning currently relies on the computation of dot-products and absolute difference of vectors, typically computed with MAC operations performed on the parameters, input data and weights. The computation of large and deep neural networks typically involves so many data elements. It is not practical to store them in processor cache, and thus they are usually stored in a memory.

Thus, machine learning is very computationally intensive with the computation and comparison of many different data elements. The computation of operations within a processor is orders of magnitude faster than the transfer of data between the processor and main memory resources. Placing all the data closer to the processor in caches is prohibitively expensive for the great majority of practical systems due to the memory sizes needed to store the data. Thus, the transfer of data becomes a major bottleneck for AI computations. As the data sets increase, the time and power/energy a computing system uses for moving data around can end up being multiples of the time and power used to actually perform computations.

CIM circuits thus perform operations locally within a memory without having to send data to a host processor. This may reduce the amount of data transferred between memory and the host processor, thus enabling higher throughput and performance. The reduction in data movement also reduces energy consumption of overall data movement within the computing device.

Although the energy consumption is reduced by performing the operations locally within a memory, the energy consumption may still occupy a certain amount due to the large amount of data. Therefore, it is the pursuit of people skilled in the art to improve the efficiency and reduce the consumption of the computation of a CIM device.

FIG. 1 is a schematic diagram of a computing circuit according to an embodiment of the disclosure. With reference to FIG. 1, a computing circuit 100 may be configured to perform a bit-serial MAC operation. That is, the multiplication in the bit-serial MAC operation may be a bit-serial multiplication.

In one embodiment, the computing circuit 100 may include a input register IR, a writer register WR, a multiplier circuit MP, an adder circuit AD, and a partial sum register PSR. The input register IR may be configured to receive an input signal IN and the input signal IN may be latched by the input register IR wordwise at one clock cycle. The weight register WR may be configured to receive a weight signal W and the weight signal W may be latched by the weight register IR bitwise at each clock cycle. The multiplier circuit MP may be configured to generate a product sum PD by multiplying the input signal IN with each bit of the weight signal W. Further, the adder circuit AD may be configured to generate a partial sum PS1 of a current cycle by adding the product sum PD to a partial sum PS0 of a previous cycle. The partial sum register PSR may be configured to latch the output of the adder circuit and output an output signal OUT.

It is noted that, a first part of the partial sum register PSR may be configured to provide a first output of the bit-serial multiplication based on the latched data (e.g., the partial sum PS1). Further, a second part of the partial sum register PSR may be configured to be clock-gated at the beginning of the MAC operation. Furthermore, the second part of the partial sum register PSR may be configured to be not clock-gated based on a first feature bit of the latched data (e.g., the partial sum PS1). In addition, the second part of the partial sum register PSR may be to provide a second output of the bit-serial multiplication. In other words, the second part of the partial sum register PSR may be dynamically inactivated (i.e., clock-gated) and activated (i.e., release clock-gating) based on the latched data (e.g., the partial sum PS1). In this manner, the energy consumption of each computation may be reduced, thereby reducing a significant amount of energy of a training of a neural network.

In one embodiment, the partial sum register PSR may be a shift register. The shift register may be configured to left shift one bit of the partial sum PS0 for every processed bit of the weight signal W. The weight signal W may be provided bitwise from the most significant bit (MSB) to the least significant bit (LSB). However, this disclosure is not limited thereto. Further, the partial sum register PSR may be a K-bit register (K is an integer greater than 2). That is, the partial sum register PSR may include K 1-bit registers, while some of the K 1-bit registers may be active at the beginning of the calculation and some of the K 1-bit registers may be inactive at the beginning of the calculation. However, this disclosure is not limited thereto.

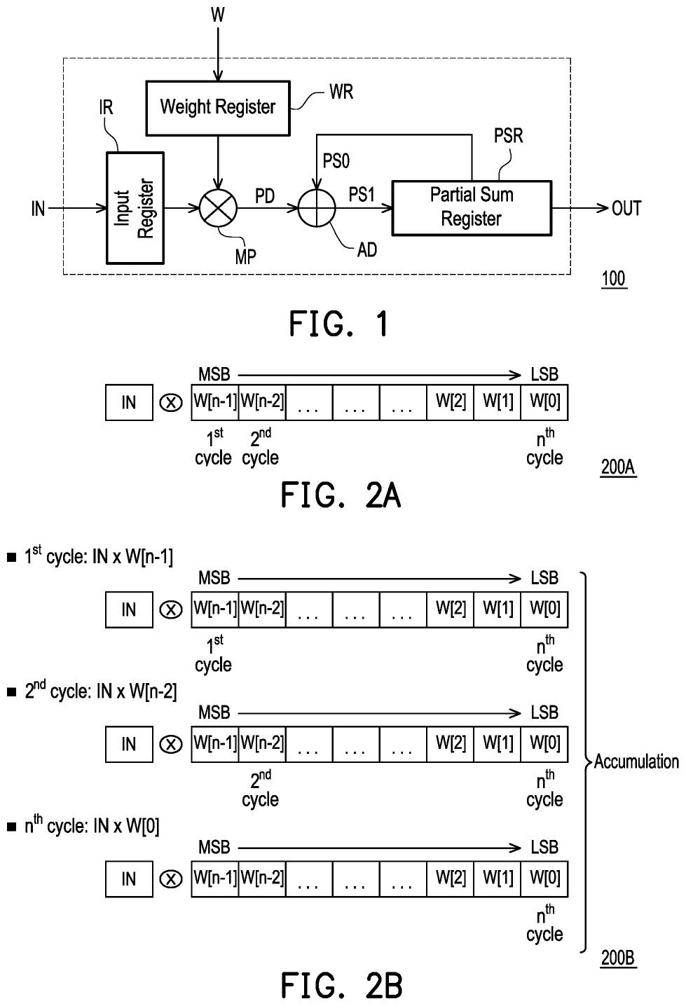

FIG. 2A is a schematic diagram of a bit-serial multiplication according to an embodiment of the disclosure. FIG. 2B is a schematic diagram of a bit-serial multiplication according to an embodiment of the disclosure. With reference to FIG. 1 to FIG. 2B, a bit-serial multiplication 200A and a bit-serial multiplication 200B depict how the input signal IN may be multiplied by the weight signal W.

In one embodiment, the computing circuit 100 may be configured to perform a calculation for a 3×3 convolution. That is, the number of the input signals IN may be 9. However, this disclosure is not limited thereto. The input signals IN and the weight signal W may be all n-bit. In one embodiment, the number n may be 8. In other words, the calculation for the 3×3 convolution may be performed by multiplying the 8-bit input signals IN by the 8-bit weight signal W. However, this disclosure is not limited thereto. Further, the input signals IN may be unsigned and the weight signal W may be signed. However, this disclosure is not limited thereto.

Referring to FIG. 2A and FIG. 2B, each of the 8-bit input signals IN may be inputted to the multiplier circuit MP wordwise and each bit of 8-bit weight may be inputted to the multiplier circuit MP bitwise from the MSB to the LSB. That is, at each cycle, the 9 8-bit input signals IN may be multiplied by one bit of the weight signal W. For example, at the first cycle, the 9 input signals IN (i.e., IN [n−1:0]) may be multiplied by the MSB (i.e., W [n−1]) of the weight signal W. At the second cycle, the 9 input signals IN may be multiplied by the bit after the MSB (i.e., W [n−2]) of the weight signal W. At the eight cycle (while n=8), the 9 input signals IN may be multiplied by the LSB (i.e., W [0]) of the weight signal W. The result of the multiplication (i.e., the product sum PD) of each cycle may be provided to the partial sum register PSR. Further, the results of the multiplications of all the cycles may be accumulated together and stored in the partial sum register PSR for outputting the output signal OUT.

It is noted that, since the 9 input signals IN and the weight signal W are all 8-bit, the total sum of all the product sums (9 pairs of 8×8 multiplications) may have at most 20 bits (8+8+log₂(9)≈20). Further, while the 9 input signals IN are inputted wordwise and the weight signal W is inputted bitwise, the result of each cycle of the multiplications (9 pairs of 8×1 multiplications) may have at most 12 bits (8+log₂(9)≈12). That is, the result may be at most 2295 (255×9=2295 while 2¹²−1, 4095). Furthermore, the accumulation of two cycles of the multiplications may have at most 14 bits. That is, the accumulation of two cycles of the multiplications may be at most 6885 (2295+2295×2=6885 while 2¹⁴−1=16383). In other words, while an addition cycle of the multiplications is added, at most two additions bits (one bit for left shifting and one bit for carry) may be required in the partial sum register PSR to store the result.

Based on the above, while the partial sum register PSR is 20-bit, at most 12 bits of the partial sum register PSR need to be activated for storing the result at the first cycle. In addition, while the number of the cycle is increased by 1, at most 2 more bits of the of the partial sum register PSR need to be activated for storing the result at the current cycle. Therefore, the upper bits of the partial sum register PSR may be clock-gated at the beginning of the calculation for the 3×3 convolution. That is, the partial sum register PSR may be configured to dynamically inactivate (i.e., clock-gating) and activate (i.e., release clock-gating) the upper bits of the partial sum register PSR. In other words, the partial sum register PSR may be considered as a data-aware self-clock-gating register and may exploit a data pattern characteristic in neural network applications. To be more specific, the accumulated product sum PD (e.g., the partial sum PS1) may have a deterministic maximum incremental value each cycle and the deterministic maximum incremental value may be utilized to selectively clock-gates the inactive registers (e.g., upper bits). In this manner, the inactive registers (e.g., upper bits) may be clock-gated to save dynamic power until the data of the register satisfies a predefined condition (e.g., bit transition), thereby reducing the power consumption during the calculation.

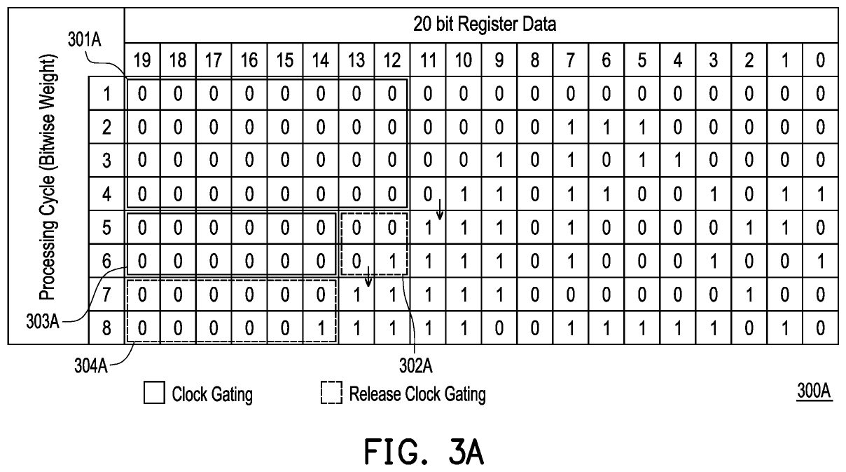

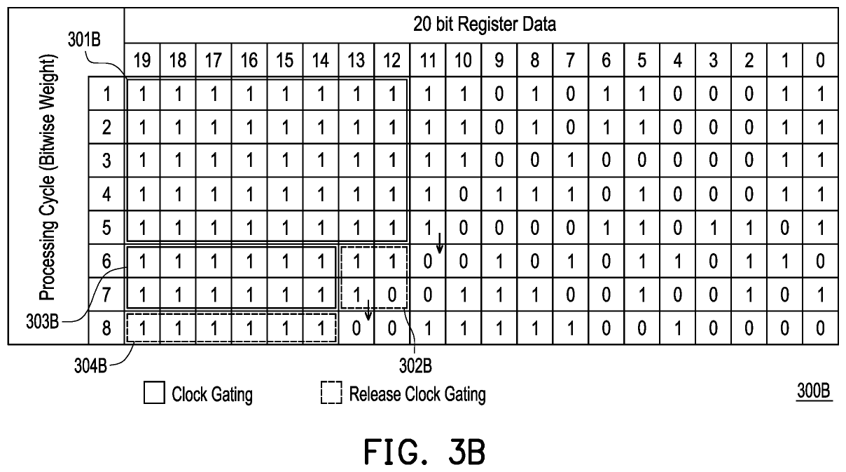

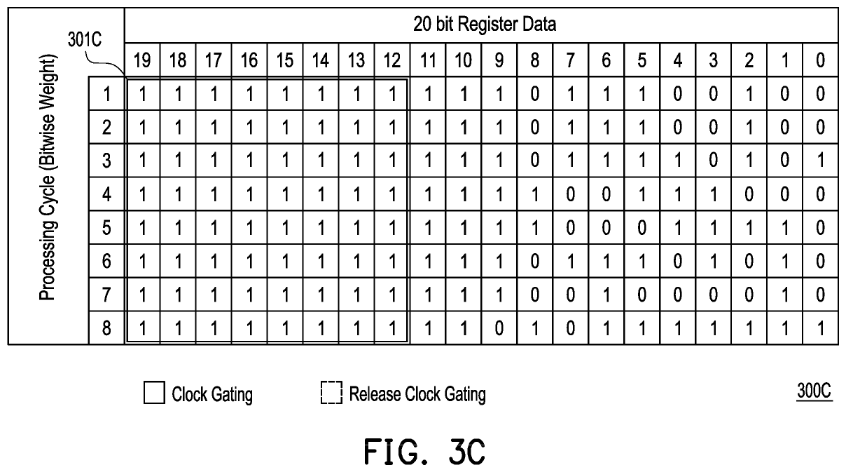

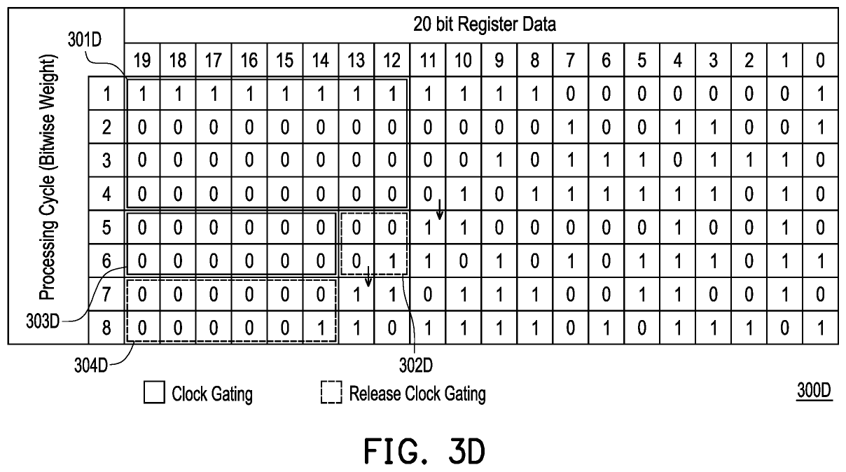

FIG. 3A is a schematic diagram of a computing scenario of a bit-serial multiplication according to an embodiment of the disclosure. FIG. 3B is a schematic diagram of a computing scenario of a bit-serial multiplication according to an embodiment of the disclosure. FIG. 3C is a schematic diagram of a computing scenario of a bit-serial multiplication according to an embodiment of the disclosure. FIG. 3D is a schematic diagram of a computing scenario of a bit-serial multiplication according to an embodiment of the disclosure. With reference to FIG. 1 to FIG. 3D, a computing scenario 300A, a computing scenario 300B, a computing scenario 300C, and a computing scenario 300D depict how the bits of the partial sum register PSR may be clock-gated or not clock-gated (release clock-gating) in with different input signals IN and different weight signals W. In one embodiment, each column represents one bit of the 20-bit data stored in the partial sum register PSR and each row represents one cycle of the bit-serial multiplication (corresponding to one bit of the weight signal W). The 20-bit data stored in the partial sum register PSR may be represented in the form of 2's complement. For example, the first row of the computing scenario 300A, the computing scenario 300B, the computing scenario 300C, and the computing scenario 300D may represent 0, −669, −284, and −255, respectively.

Referring to FIG. 3A, before the first cycle, the data stored in the partial sum register may be reset. Then, at the first cycle, the data stored in the partial sum register PSR may be replaced by the product sum PD of the 9 input signals IN and the MSB of the weight signal. For example, the stored data may be 0. The stored data may be determined as the partial sum PS1 of a current cycle, which is later considered as the partial sum PS0 of a previous cycle. In other words, the partial sum PS1 may be inputted to the partial sum register PSR, which may be known as an input data DIN (not shown).

At the second cycle, the product sum PD of the 9 input signals IN and the next bit of the MSB of the weight signal may be calculated. The product sum PD of the current cycle and the partial sum PS0 of the previous cycle may be added together to become the partial sum PS1 of the current cycle. The partial sum PS1 may be inputted to the partial sum register PSR as the input data DIN. For example, the input data DIN at the second cycle may be 224 (converting 0000 0000 0000 1110 0000 from 2's complement to decimal). At the third cycle and the fourth cycle, similar calculations maybe performed. The input data DIN at the third cycle and the fourth cycle may be 688 and 1739, respectively.

It is noted that, from the first cycle to the fourth cycle, only 12 lower bits (e.g., DIN[11:0]) of the partial sum register PSR are active. That is, the 8 upper bits (e.g., DIN[19:12]) of the partial sum register PSR may be clock-gated to save dynamic power until the highest bit (e.g., DIN[11]) of the active part (e.g., DIN[11:0]), also known as a first part) of the partial sum register PSR being changed. On the other hand, in response to a bit transition of a highest bit (e.g., DIN[11]) is switched from 0 to 1 at the fifth cycle) of the active part (e.g., DIN[11:0]) of the partial sum register PSR, a triggered part 302A (also known as a second part) of the inactive part 301A of the of the partial sum register PSR may be activated (e.g., release clock-gating) to store more data. In one embodiment, two more bits (e.g. DIN[13:12]) of the partial sum register PSR may be the trigger part 302A and released from clock-gating. In another embodiment, all the rest of the bits (e.g., DIN[19:12]) of the partial sum register PSR may be the trigger part 302A and released from clock-gating. However, this disclosure is not limited thereto.

Further, from the fifth cycle to the sixth cycle, only 14 lower bits (e.g., DIN[13:0]) of the partial sum register PSR may be used. That is, the 6 upper bits (e.g., DIN[19:14]) of the partial sum register PSR may be clock-gated to save dynamic power until the highest bit (e.g., DIN[13]) of the active part (e.g., DIN[13:0]), aka the first part and the second part) of the partial sum register PSR being changed. On the other hand, in response to a bit transition of a highest bit (e.g., DIN[13]) is switched from 0 to 1 at the seventh cycle) of the active part (e.g., DIN[13:0]) of the partial sum register PSR, a trigger part 304A (also known as a third part) of an inactive part 303A of the of the partial sum register PSR may be activated (e.g., release clock-gating) to store more data. In one embodiment, two more bits (e.g. DIN[15:14]) of the partial sum register PSR may be the trigger part 304A and released from clock-gating. In another embodiment, all the rest of the bits (e.g., DIN[19:14]) of the partial sum register PSR may be the trigger part 304A and released from clock-gating. However, this disclosure is not limited thereto.

Referring to FIG. 3B, the input data DIN inputted to the partial sum register PSR from the first cycle to the fifth cycle may be −669, −669, −893, −1117, and −1939, respectively. The details of the calculation may be referred to the descriptions of FIG. 3A to obtain sufficient teachings, suggestions, and implementation embodiments, while the details are not redundantly described seriatim herein.

It is noted that, from the first cycle to the fifth cycle, only 12 lower bits (e.g., DIN[11:0]) of the partial sum register PSR are active. That is, the 8 upper bits (e.g., DIN[19:12]) of the partial sum register PSR may be clock-gated to save dynamic power until the highest bit (e.g., DIN[11]) of the active part (e.g., DIN[11:0]) of the partial sum register PSR being changed. On the other hand, in response to a bit transition of a highest bit (e.g., DIN[11] is switched from 1 to 0 at the sixth cycle, which is shown as an arrow in the figure) of the active part (e.g., DIN[11:0]) of the partial sum register PSR, a trigger part 302B of an inactive part 301B of the of the partial sum register PSR may be activated (e.g., release clock-gating) to store more data. In one embodiment, two more bits (e.g. DIN[13:12]) of the partial sum register PSR may be the trigger part 302B and released from clock-gating. In another embodiment, all the rest of the bits (e.g., DIN[19:12]) of the partial sum register PSR may be the trigger part 302B and released from clock-gating. However, this disclosure is not limited thereto.

Further, from the sixth cycle to the seventh cycle, only 14 lower bits (e.g., DIN[13:0]) of the partial sum register PSR may be used. That is, the 6 upper bits (e.g., DIN[19:14]) of the partial sum register PSR may be clock-gated to save dynamic power until the highest bit (e.g., DIN[13]) of the active part (e.g., DIN[13:0]) of the partial sum register PSR being changed. On the other hand, in response to a bit transition of a highest bit (e.g., DIN[13] is switched from 1 to 0 at the eighth cycle, which is shown as an arrow in the figure) of the active part of the partial sum register PSR, a trigger part 304B of an inactive part 303B of the of the partial sum register PSR may be activated (e.g., release clock-gating) to store more data. In one embodiment, two more bits (e.g. DIN[15:14]) of the partial sum register PSR may be the trigger part 304B and released from clock-gating. In another embodiment, all the rest of the bits (e.g., DIN[19:14]) of the partial sum register PSR may be the trigger part 304B and released from clock-gating. However, this disclosure is not limited thereto.

Referring to FIG. 3C, the input data DIN inputted to the partial sum register PSR from the first cycle to the fifth cycle may be −284, −284, −267, −200, −226, −278, −446, and −641, respectively. The details of the calculation may be referred to the descriptions of FIG. 3A to obtain sufficient teachings, suggestions, and implementation embodiments, while the details are not redundantly described seriatim herein.

It is noted that, from the first cycle to the eighth cycle, only 12 lower bits (e.g., DIN[11:0]) of the partial sum register PSR are active. That is, the 8 upper bits (e.g., DIN[19:12]) of the partial sum register PSR may be clock-gated as an inactive part 301C to save dynamic power until the highest bit (e.g., DIN[11]) of the active part (e.g., DIN[11:0]) of the partial sum register PSR being changed.

Referring to FIG. 3D, the input data DIN inputted to the partial sum register PSR from the first cycle to the fourth cycle may be −255, 153, 750, and 1530, respectively. The details of the calculation may be referred to the descriptions of FIG. 3A to obtain sufficient teachings, suggestions, and implementation embodiments, while the details are not redundantly described seriatim herein.

It is noted that, from the first cycle to the fourth cycle, only 12 lower bits (e.g., DIN[11:0]) of the partial sum register PSR are active. That is, the 8 upper bits (e.g., DIN[19:12]) of the partial sum register PSR may be clock-gated to save dynamic power until the highest bit (e.g., DIN[11]) of the active part (e.g., DIN[11:0]) of the partial sum register PSR being changed. On the other hand, in response to a bit transition of a highest bit (e.g., DIN[11] is switched from 0 to 1 at the fifth cycle) of the active part (e.g., DIN[11:0]) of the partial sum register PSR, a trigger part 302D of an inactive part 301D of the of the partial sum register PSR may be activated (e.g., release clock-gating) to store more data. In one embodiment, two more bits (e.g. DIN[13:12]) of the partial sum register PSR may be the trigger part 302D and released from clock-gating. In another embodiment, all the rest of the bits (e.g., DIN[19:12]) of the partial sum register PSR may be the trigger part 302D and released from clock-gating. However, this disclosure is not limited thereto.

Further, from the fifth cycle to the sixth cycle, only 14 lower bits (e.g., DIN[13:0]) of the partial sum register PSR may be used. That is, the 6 upper bits (e.g., DIN[19:14]) of the partial sum register PSR may be clock-gated to save dynamic power until the highest bit (e.g., DIN[13]) of the active part (e.g., DIN[13:0]) of the partial sum register PSR being changed. On the other hand, in response to a bit transition of a highest bit (e.g., DIN[11] is switched from 0 to 1 at the seventh cycle) of the active part of the partial sum register PSR, a trigger part 304D of an inactive part 303D of the of the partial sum register PSR may be activated (e.g., release clock-gating) to store more data. In one embodiment, two more bits (e.g. DIN[15:14]) of the partial sum register PSR may be the trigger part 304D and released from clock-gating. In another embodiment, all the rest of the bits (e.g., DIN[19:14]) of the partial sum register PSR may be the trigger part 304D and released from clock-gating. However, this disclosure is not limited thereto.

In addition, from the first cycle to the second cycle, the value of the stored data in the partial sum register PSR may be switched from a negative value (e.g., −255) to a positive value (e.g., 153). Since the leading bit stands for the sign bit in the 2's complement, the MSB of the stored data may be switched from 1 to 0. While the MSB (i.e., DIN[19]) is switched, the highest bit (e.g., DIN[11]) of the active part (e.g., DIN[11:0]) is also switched from 1 to 0. However, the bit transition from the first cycle to the second cycle is not due to the stored data is greater than a maximum value of the active part. Therefore, none of the inactive part 301D is necessary to be released from clocking for storing more data. That is, the inactive part 301D of the of the partial sum register PSR may be still clock-gated to save dynamic energy.

Based on the above, a rule for the clock-gating of the partial sum register PSR may be established in the following manner. In one embodiment, at a beginning of a calculation for a convolution, a first part of the partial sum register PSR may be active and a second part of the partial sum register PSR may be clock-gated. Further, during the calculation, the MSB of the input data DIN stored in the partial sum register PSR may be monitored.

Furthermore, the second part of the partial sum register PSR may be determined whether not to be clock-gated or not based on a first feature bit of the partial sum PS1 (i.e., the input data DIN) inputted to the partial sum register PSR. For example, the first feature bit may be the highest bit of the first part of the partial sum register PSR. That is, the first feature bit may be monitored to determine the release of the clock-gating of the second part. To be more specific, in response to a bit transition (e.g., 0→1 while the MSB=0 or 1→0 while the MSB=1) of the first feature bit during the calculation, the second part of the partial sum register may be released from clock-gating to receive the partial sum PS1 as the input data DIN. In one embodiment, the second part may be a trigger part of an inactive part of the partial sum register PSR. In another embodiment, the second part may be the whole part of the inactive part of the partial sum register PSR.

In addition, two or more stages of clock-gating may be designed according to actual needs. For example, a third part (e.g., the trigger part 304A, 304B, 304D) may be further released from clock-gated to receive the partial sum PS1 as the input data DIN. That is, the third part of the partial sum register PSR may be determined whether not to be clock-gated or not based on a second feature bit of the partial sum PS1 (i.e., the input data DIN) inputted to the partial sum register PSR. For example, the second feature bit may be the highest bit of the second part of the partial sum register PSR. The rest of the details may be referred to the second part, while the details are not redundantly described seriatim herein. Similarly, a fourth part and a fifth part may be designed according to actual needs.

It is noted that, while it is assumed for the sake of convenience in explanation that the partial sum register PSR may have 20 bits, the number of the initial clock-gated bits may be 8, and the number of the bits released while triggered may be 2, this disclosure is not limited to the number of the bits mentioned above.

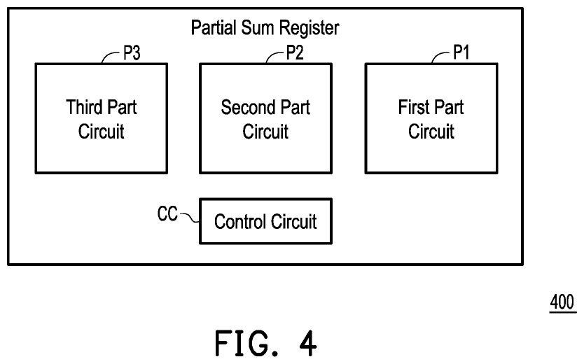

FIG. 4 is a schematic diagram of a partial sum register according to an embodiment of the disclosure. With reference to FIG. 1 to FIG. 4, a partial sum register 400 is an embodiment of the partial sum register PSR of the computing circuit 100, but this disclosure is not limited thereto. The partial sum register 400 may include a first part circuit P1, a second part circuit P2, a third part circuit P3, and a control circuit CC. In one embodiment, the first part circuit P1, the second part circuit P2, and the third part circuit P3 may be an embodiment of the first part, the second part, and the third part of the partial sum register PSR described in the description of FIG. 3A to FIG. 3D. However, this disclosure is not limited thereto.

In one embodiment, computing circuit 100 may be configured to perform a bit-serial multiplication of the input signal IN and the weight signal W. The first part circuit P1, the second part circuit P2, and the third part circuit P3 may be configured to receive the partial sum PS1 as input data DIN. At the beginning of the bit-serial multiplication, the second part circuit P2 and the third part circuit P3 may be clock-gated. The first part circuit P1 (aka the first part) may be configured to provide a first output based on the partial sum PS1. The second part circuit P2 may be configured to be released from the clock-gating based on a first feature bit of the partial sum PS1. The third part circuit P3 may be configured to be released from the clock-gating based on a second feature bit of the partial sum PS1. The control circuit CC may be configured to determine whether to release the clock-gating of the second part circuit P2 (aka the second part) and release the clock-gating of the third part circuit P3 (aka the third part), respectively. After the second part circuit P2 is released from the clock-gating, the second part circuit P2 may be configured to provide a second output. After the third part circuit P3 is released from the clock-gating, the third part circuit P3 may be configured to provide a third output. The first output, the second output, and the third output together may be regarded as an output data DOUT (not shown).

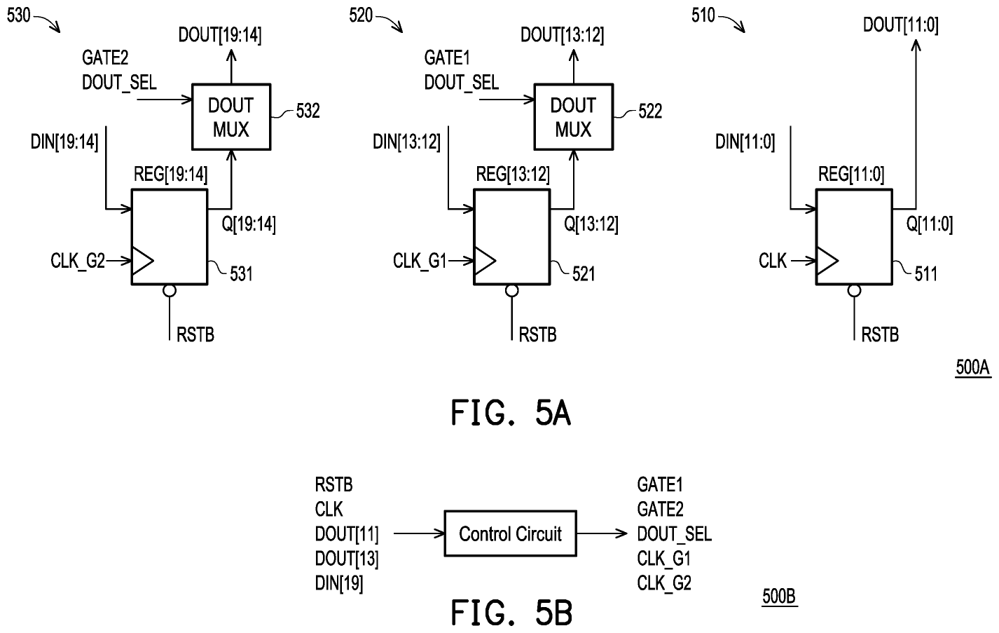

FIG. 5A is a schematic diagram of a circuit structure of a partial sum register according to an embodiment of the disclosure. FIG. 5B is a schematic diagram of a circuit structure of a partial sum register according to an embodiment of the disclosure. With reference to FIG. 1 to FIG. 5B, a circuit structure 500A and a circuit structure 500B are depicted. In one embodiment, the circuit structure 500A may be one exemplary embodiment of the of the first part circuit P1, the second part circuit P2, and the third part circuit P3 of the partial sum register 400 and the circuit structure 500B may be one exemplary embodiment of the control circuit CC of the partial sum register 400. However, this disclosure is not limited thereto.

Referring to FIG. 5A, the circuit structure 500A may include a first part circuit 510, a second part circuit 520, and a third part circuit 530. The first part circuit 510, the second part circuit 520, and the third part circuit 530 may be an embodiment of the first part circuit P1, the second part circuit P2, and the third part circuit P3, but this disclosure is not limited thereto.

Referring to the first part circuit 510, the first part circuit 510 may include a register 511. The register 511 may be configured to receive and store 12 bits of the input data DIN as the first input DIN[11:0]. Further, the register 511 may be configured to receive a clock signal CLK, and a reset bar signal RSTB. Furthermore, the register 511 may be configured to provide a first data Q[11:0] as a first output DOUT[11:0], while the first output DOUT[11:0] may be regarded as 12 bits of the output data DOUT.

Referring to the second part circuit 520, the second part circuit 520 may include a register 521 and an output data multiplexer (MUX) 522. The register 521 may be configured to receive and store 2 bits of the input data DIN as the second input DIN[13:12]. Further, the register 521 may be configured to receive a clock signal CLK_G1, and the reset bar signal RSTB. Furthermore, the register 521 may be configured to provide a second data Q[13:12] to the output data MUX 522. Moreover, the output data MUX 522 may be configured to receive the second data Q[13:12], a output bypass data DOUT_SEL, and a gating signal GATE1 (aka a first gating signal). In addition, the output data MUX 522 may be configured to output one of the second data Q[13:12] and the output bypass data DOUT_SEL as a second output DOUT[13:12], while the second output DOUT[13:12] may be regarded as 2 bits of the output data DOUT.

Referring to the third part circuit 530, the third part circuit 530 may include a register 531 and an output data MUX 532. The register 531 may be configured to receive and store 6 bits of the input data DIN as the third input DIN[19:14]. Further, the register 531 may be configured to receive a clock signal CLK_G2, and the reset bar signal RSTB. Furthermore, the register 531 may be configured to provide a third data Q[19:14] to the output data MUX 532. Moreover, the output data MUX 532 may be configured to receive the third data Q[19:14], the output bypass data DOUT_SEL, and a gating signal GATE2 (aka a second gating signal). In addition, the output data MUX 532 may be configured to output one of the third data Q[19:14] and the output bypass data DOUT_SEL as a third output DOUT[19:14], while the third output DOUT[19:14] may be regarded as 6 bits of the output data DOUT.

It is noted that, the first input DIN[11:0], the second input DIN[13:12], and the third input DIN[19:14] together may be regarded as the input data DIN (i.e., DIN[19:0]). Similarly, the first output DOUT[11:0], the second output DOUT[13:12], and the third output DOUT[19:14] together may be regarded as the output data DOUT (i.e., DOUT[19:0]). Furthermore, the first data Q[11:0], the second data Q[13:12], and the Q[19:14] together may be regarded as a data signal Q (i.e., Q[19:0]) (not shown). However, this disclosure is noted limited thereto.

Referring to FIG. 5B, the circuit structure 500B may include the control circuit CC. The control circuit CC may be configured to receive the reset bar signal RSTB, the clock signal CLK, a first feature bit signal DOUT[11], a second feature bit signal DOUT[13], and a MSB signal DIN[19]. Further, the control circuit CC may be configured to provide the gating signal GATE1, the gating signal GATE2, the output bypass data DOUT_SEL, the clock signal CLK_G1, and the clock signal CLK_G2.

Furthermore, the control circuit CC may be configured to determine whether to release the clock-gating of the second part circuit 520 (aka the second part) and release the clock-gating of the third part circuit 530 (aka the third part), respectively. To be more specific, the control circuit CC may be configured to control the second part circuit 520 to output one of the second data Q[13:12] and the output bypass data DOUT_SEL as the second output DOUT[13:12] based on the first feature bit signal DOUT[11]. Similarly, the control circuit CC may be configured to control the third part circuit 530 to output one of the third data Q[19:14] and the output bypass data DOUT_SEL as the third output DOUT[19:14] based on the second feature bit signal DOUT[13].

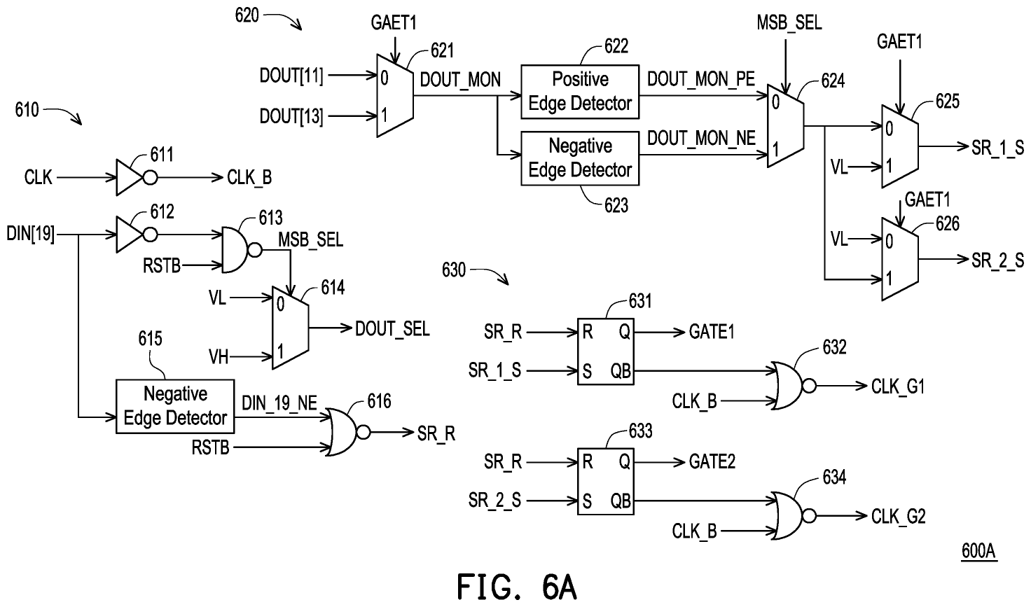

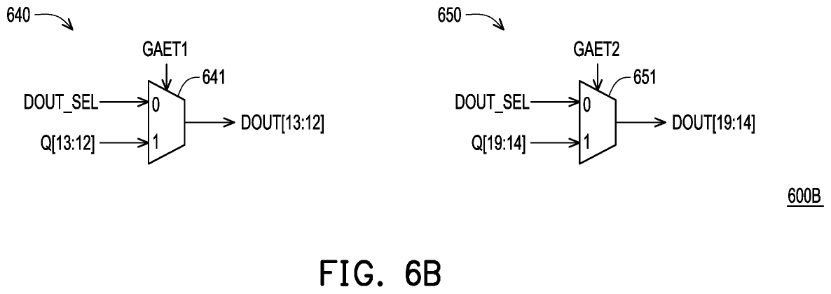

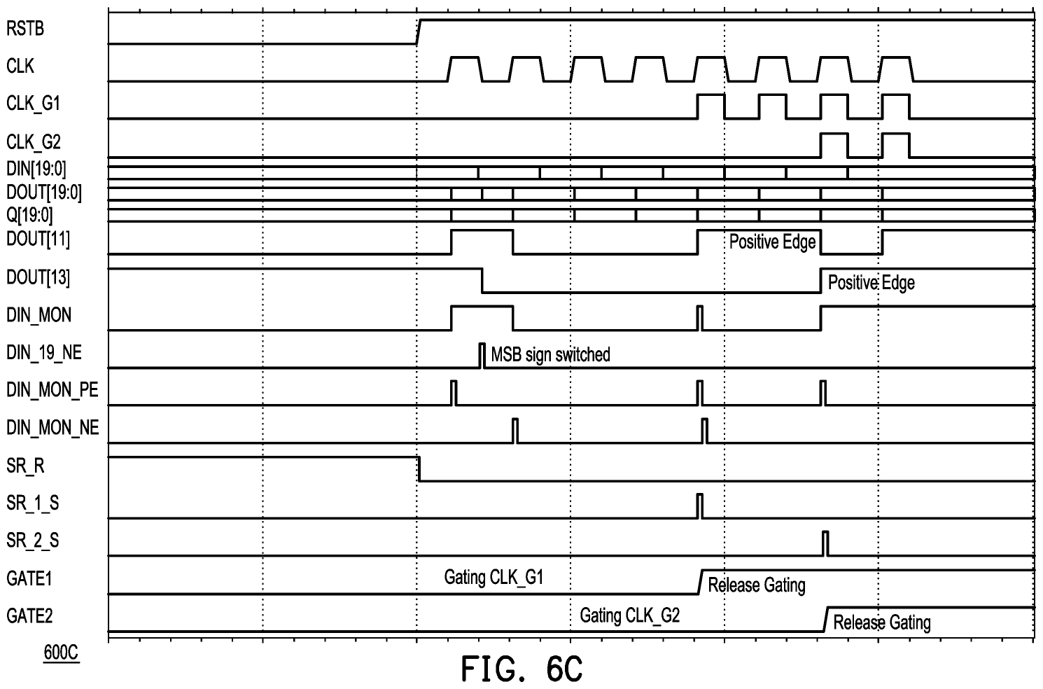

FIG. 6A is a schematic diagram of a circuit structure of a partial sum register according to an embodiment of the disclosure. FIG. 6B is a schematic diagram of a circuit structure of a partial sum register according to an embodiment of the disclosure. With reference to FIG. 1 to FIG. 6B, a circuit structure 600A and a circuit structure 600B are depicted. In one embodiment, the circuit structure 600A may be one exemplary embodiment of the control circuit CC of the partial sum register 400 and the circuit structure 600B may be one exemplary embodiment of the output data MUX 522 and the output data MUX 532. However, this disclosure is not limited thereto.

Referring to FIG. 6A, the circuit structure 600A may include a MSB monitoring circuit 610, a feature bit monitoring circuit 620, and a latch circuit 630. The MSB monitoring circuit 610 may include an invertor 611, an invertor 612, a NAND gate 613, a MUX 614, a negative edge detector 615, and a NOR gate 616. The feature bit monitoring circuit 620 may include a MUX 621, a positive edge detector 622, a negative edge detector 623, a MUX 624, a MUX 625, and a MUX 626. The latch circuit 630 may include a set reset latch (SR latch) 631 (aka a first SR latch), a NOR gate 632, a SR latch 633 (aka a second SR latch), and a NOR gate 634.

Referring to the MSB monitoring circuit 610, the invertor 611 may be configured to receive the clock signal CLK and to provide the clock signal CLK_B. The invertor 612 may be configured to receive the MSB signal DIN[19] and to provide an inverse of the MSB signal DIN[19]. The NAND gate 613 may be configured to receive the inverse of the MSB signal DIN[19] and the reset bar signal RSTB and to provide a MSB following signal MSB_SEL. The MUX 614 may be configured to receive a logic low signal VL, a logic high signal VH, and the MSB following signal MSB_SEL and to provide one of the logic low signal VL and the logic high signal VH based on the MSB following signal MSB_SEL. The negative edge detector 615 may be configured to receive the MSB signal DIN[19] and to provide a MSB switch signal DIN_19_NE by detecting a negative edge of the MSB signal DIN[19]. The NOR gate 616 may be configured to receive the MSB switch signal DIN_19_NE and the reset bar signal and to provide a latching signal SR_R (aka a reset latching signal).

Referring to the feature bit monitoring circuit 620, the MUX 621 may be configured to receive the first feature bit signal DOUT[11], the second feature bit signal DOUT[13], and the gating signal GATE1 and to provide one of the first feature bit signal DOUT[11] and the second feature bit signal DOUT[13] as the feature bit monitoring signal DOUT_MON. The positive edge detector 622 may be configured to receive the feature bit monitoring signal DOUT_MON and to provide a trigger signal DOUT_MON_PE (aka a positive trigger signal) by detecting a positive edge of the feature bit monitoring signal DOUT_MON. The negative edge detector 623 may be configured to receive the feature bit monitoring signal DOUT_MON and to provide a trigger signal DOUT_MON_NE (aka a negative trigger signal) by detecting a negative edge of the feature bit monitoring signal DOUT_MON. The MUX 624 may be configured to receive the trigger signal DOUT_MON_PE, the trigger signal DOUT_MON_NE, and the MSB following signal MSB_SEL and to provide one of the trigger signal DOUT_MON_PE and the trigger signal DOUT_MON_NE based on the MSB following signal MSB_SEL. The MUX 625 may be configured to receive the MSB following signal MSB_SEL, the logic low signal VL, and the gating signal GATE1 and to provide one of the MSB following signal MSB_SEL and the logic low signal VL as a latching signal SR_1_S (aka a first latching signal). The MUX 626 may be configured to receive the logic low signal VL, the MSB following signal MSB_SEL, and the gating signal GATE1 and to provide one of the logic low signal VL and the MSB following signal MSB_SEL as a latching signal SR_2_S (aka a second latching signal).

Referring to the latch circuit 630, the SR latch 631 may be configured to receive the latching signal SR_R and the latching signal SR_1_S and to provide the gating signal GATE1 and the inverse of the gating signal GATE1. The NOR gate 632 may be configured to receive the inverse of the gating signal GATE1 and the clock signal CLK_B and to provide the clock signal CLK_G1. That is, the gating signal GATE1 is configured to perform the gating of the clock signal CLK_G1. The SR latch 633 may be configured to receive the latching signal SR_R and the latching signal SR_2_S and to provide the gating signal GATE2 and the inverse of the gating signal GATE2. The NOR gate 634 may be configured to receive the inverse of the gating signal GATE2 and the clock signal CLK_B and to provide the clock signal CLK_G2. That is, the gating signal GATE2 is configured to perform the gating of the clock signal CLK_G2.

Referring to FIG. 6B, the circuit structure 600B may include a MUX circuit 640 and a MUX circuit 650. The MUX circuit 640 and the MUX circuit may be one exemplary embodiment of the output data MUX 522 and the output data MUX 532. However, this disclosure is not limited thereto.

Referring to the MUX circuit 640, the MUX circuit 640 may include a MUX 641. The MUX 641 may be configured to receive the output bypass data DOUT_SEL, the second data Q[13:12], and the gating signal GATE1 and to provide one of the output bypass data DOUT_SEL and the second data Q[13:12] as the second output DOUT[13:12] based on the gating signal GATE1.

Referring to the MUX circuit 650, the MUX circuit 650 may include a MUX 651. The MUX 651 may be configured to receive the output bypass data DOUT_SEL, the third data Q[19:14], and the gating signal GATE2 and to provide one of the output bypass data DOUT_SEL and the third data Q[19:14] as the third output DOUT[19:14] based on the gating signal GATE2.

FIG. 6C is a schematic diagram of a timing chart of partial sum register according to an embodiment of the disclosure. With reference to FIG. 1 to FIG. 6C, a timing chart 600C may be one exemplary embodiment of a timing chart of the computing scenario 300D of FIG. 3D. However, this disclosure is not limited thereto.

Referring to FIG. 6C, the timing chart 600C may include the reset bar signal RSTB, the clock signal CLK, the clock signal CLK_G1, the clock signal CLK_G2, the input data DIN (i.e., DIN[19:0]), the output data DOUT (i.e., DOUT[19:0]), the data signal Q (i.e., Q[19:0]), the first feature bit signal DIN[11], the second feature bit signal DIN[13], the feature bit monitoring signal DOUT_MON, the MSB switch signal DIN_19_NE, the trigger signal DOUT_MON_PE, the trigger signal DOUT_MON_NE, the latching signal SR_R, the latching signal SR_1_S, the latching signal SR_2_S, the gating signal GATE1, and the gating signal GATE2.

In one embodiment, while the reset bar is switched from a logic low (e.g., “0”) to a logic high (e.g., “1”), the partial sum register 400 may be enabled. The SR latch 631 and the SR latch 633 may be reset by the SR_R. The clock signal CLK may be provided to synchronize the operations of all the circuits in the partial sum register 400. The input data DIN, the output DATA DOUT, and the data signal Q may be switched according to the input signal IN and the weight signal W. The MSB switch signal DIN_19_NE may be triggered while the MSB of the partial sum PS1 is switched. The trigger signal DOUT_MON_PE or the trigger signal DOUT_MON_NE may be triggered while a positive edge or negative edge of the partial sum PS1 (i.e., the input data DIN) is detected. The gating signal GATE1 and the gating signal GATE2 may be configured to clock-gating or release the clock-gating the second part circuit P2 and the third part circuit P3, respectively.

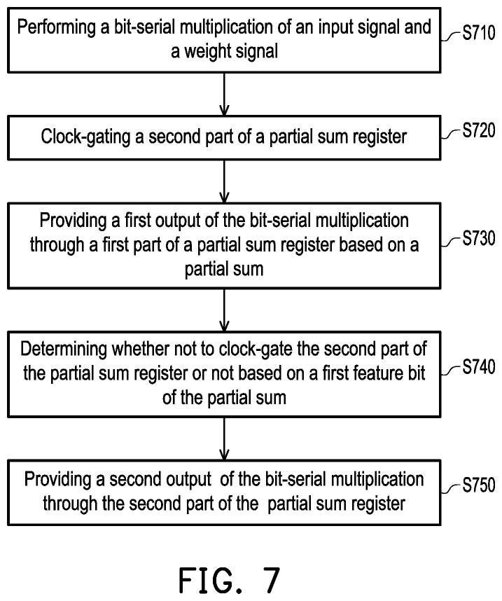

FIG. 7 is a schematic flowchart of a computing method according to an embodiment of the disclosure. With reference to FIG. 1 to FIG. 7, a computing method 700 may include a step S710, a step S720, a step S730, a step S740, and a step S750.

In the step S710, a bit-serial multiplication of the input signal IN and the weight signal W may be performed by the computing circuit 100. In the step S720, a second part of the partial sum register PSR of the computing circuit 100 may be clock-gated. In the step S730, a first out of the bit-serial multiplication may be provided through a first part of the partial sum register PSR based on the partial sum PS1. In the step S740, whether not to clock-gate the second part of the partial sum register or not may be determined based on a first feature bit of the partial sum PS1. In the step S750, a second output of the bit-serial multiplication may be provided through the second part of the partial sum register PSR. In this manner, the energy consumption of each computation may be reduced, thereby reducing a significant amount of energy of a training of a neural network.

In addition, the implementation details of the computing method 700 may be referred to the descriptions of FIG. 1 to FIG. 7 to obtain sufficient teachings, suggestions, and implementation embodiments, while the details are not redundantly described seriatim herein.

In summary, according to the computing circuit, the partial sum register, and the computing method, the inactive registers may be clock-gated to save dynamic power until the data of the register satisfies a predefined condition, thereby reducing the power consumption during the calculation.

In one embodiment, a computing circuit is configured to perform a bit-serial multiplication of an input signal and a weight signal. A multiplier circuit is configured to receive the input signal and the weight signal and to provide a product sum. An adder circuit is configured to receive the product sum and to provide a partial sum. A partial sum register is configured to: clock-gate a second part of the partial sum register; receive the partial sum; provide, based on the partial sum, a first output of the bit-serial multiplication through a first part of the partial sum register; determine whether not to clock-gate the second part of the partial sum register or not based on a first feature bit of the partial sum; and provide, based on the first feature bit of the partial sum, a second output of the bit-serial multiplication through the second part of the partial sum register.

In a related embodiment, the first feature bit is a highest bit of the first part of the partial sum register.

In a related embodiment, the partial sum register is further configured to: in response to a bit transition of the first feature bit, release a clock-gating of the second part of the partial sum register.

In a related embodiment, the partial sum is represented in a 2's complement form and the partial sum register is further configured to: in response to a most significant bit of the partial sum is 0, determine the bit transition of the first feature bit being switched from 0 to 1.

In a related embodiment, the partial sum is represented in a 2's complement form and the partial sum register is further configured to: in response to a most significant bit of the partial sum is 1, determine the bit transition of the first feature bit being switched from 1 to 0.

In a related embodiment, the partial sum register is further configured to: clock-gate a third part of the partial sum register; determine whether not to clock-gate the second part of the partial sum register or not based on a second feature bit of the partial sum; and provide, based on the second feature bit of the partial sum, a third output of the bit-serial multiplication through the second part of the partial sum register.

In a related embodiment, the second feature bit is a highest bit of the second part of the partial sum register.

In a related embodiment, the partial sum register is further configured to: in response to a bit transition of the second feature bit, release a clock-gating of the third part of the partial sum register.

In one embodiment, a partial sum register is configured to: clock-gate a second part circuit of the partial sum register; receive a partial sum of a bit-serial multiplication of an input signal and a weight signal; provide, based on the partial sum, a first output of the bit-serial multiplication through a first part circuit of the partial sum register; determine whether not to clock-gate the second part circuit of the partial sum register or not based on a first feature bit of the partial sum; and provide, based on the first feature bit of the partial sum, a second output of the bit-serial multiplication through the second part circuit of the partial sum register.

In a related embodiment, the partial sum register includes: the first part circuit, configured to receive a first input of an input data inputted to the partial sum; the second part circuit, configured to receive a second input of the input data; and a control circuit, configured to release a clock-gating of the second part circuit based on the first feature bit.

In a related embodiment, the control circuit includes: a most significant bit monitoring circuit, configured to detect a negative edge of a most significant bit of the partial sum; a feature bit monitoring circuit, configured to detect a positive edge or a negative edge of the first feature bit; and a latch circuit, configured to provide a first gating signal for clock-gating the second part circuit.

In a related embodiment, the most significant bit monitoring circuit includes: a negative edge detector, configured to detect the negative edge of the most significant bit of the partial sum and to provide a most significant bit switch signal; and a NOR gate, configured to receive the most significant bit switch signal and a reset bar signal and provide a reset latching signal to the latch circuit.

In a related embodiment, the feature bit monitoring circuit includes: a positive edge detector, configured to detect the positive edge of the first feature bit and to provide a positive trigger signal; a negative edge detector, configured to detect the negative edge of the first feature bit and to provide a negative trigger signal; and a multiplexer, configured to receive one of the positive trigger signal and the negative signal, to receive a logic low signal and the first gating signal, and to provide, based on the first gating signal, one of the positive trigger signal, the negative signal, and the logic low signal as a first latching signal to the latch circuit.

In a related embodiment, the latching circuit includes: a first SR latch, configured to receive a reset latching signal and a first latching signal and to provide the first gating signal.

In a related embodiment, the partial sum register further includes: a third part circuit, configured to receive a third input of the input data; and a control circuit, configured to clock-gate or release a clock-gating of the third part circuit based on a second feature bit of the partial sum.

In one embodiment, a computing method includes: clock-gating a second part circuit of a partial sum register; receiving a partial sum of a bit-serial multiplication of an input signal and a weight signal; providing, based on the partial sum, a first output of the bit-serial multiplication through a first part circuit of the partial sum register; determining whether not to clock-gate the second part circuit of the partial sum register or not based on a first feature bit of the partial sum; and providing, based on the first feature bit of the partial sum, a second output of the bit-serial multiplication through the second part circuit of the partial sum register.

In a related embodiment, wherein the first feature bit is a highest bit of the first part of the partial sum register.

In a related embodiment, the computing method further includes: in response to a bit transition of the first feature bit, releasing a clock-gating of the second part of the partial sum register.

In a related embodiment, the computing method further includes: representing the partial sum in a 2's complement form; and

in response to a most significant bit of the partial sum is 0, determining the bit transition of the first feature bit being switched from 0 to 1.

In a related embodiment, the computing method further includes: representing the partial sum in a 2's complement form; and in response to a most significant bit of the partial sum is 1, determining the bit transition of the first feature bit being switched from 1 to 0.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A computing circuit, configured to perform a bit-serial multiplication of an input signal and a weight signal and comprising:
a multiplier circuit, configured to receive the input signal and the weight signal and to provide a product sum;
an adder circuit, configured to receive the product sum and to provide a partial sum; and
a partial sum register, configured to:
clock-gate a second part of the partial sum register;
receive the partial sum;
provide, based on the partial sum, a first output of the bit-serial multiplication through a first part of the partial sum register;
determine whether not to clock-gate the second part of the partial sum register or not based on a first feature bit of the partial sum; and
provide, based on the first feature bit of the partial sum, a second output of the bit-serial multiplication through the second part of the partial sum register.

2. The computing circuit according to claim 1, where the first feature bit is a highest bit of the first part of the partial sum register.

3. The computing circuit according to claim 1, wherein the partial sum register is further configured to:
in response to a bit transition of the first feature bit, release a clock-gating of the second part of the partial sum register.

4. The computing circuit according to claim 3, wherein the partial sum is represented in a 2's complement form and the partial sum register is further configured to:
in response to a most significant bit of the partial sum is 0, determine the bit transition of the first feature bit being switched from 0 to 1.

5. The computing circuit according to claim 3, wherein the partial sum is represented in a 2's complement form and the partial sum register is further configured to:
in response to a most significant bit of the partial sum is 1, determine the bit transition of the first feature bit being switched from 1 to 0.

6. The computing circuit according to claim 1, wherein the partial sum register is further configured to:
clock-gate a third part of the partial sum register;
determine whether not to clock-gate the second part of the partial sum register or not based on a second feature bit of the partial sum; and
provide, based on the second feature bit of the partial sum, a third output of the bit-serial multiplication through the second part of the partial sum register.

7. The computing circuit according to claim 6, where the second feature bit is a highest bit of the second part of the partial sum register.

8. The computing circuit according to claim 6 wherein the partial sum register is further configured to:
in response to a bit transition of the second feature bit, release a clock-gating of the third part of the partial sum register.

9. A partial sum register, configured to:
clock-gate a second part circuit of the partial sum register;
receive a partial sum of a bit-serial multiplication of an input signal and a weight signal;
provide, based on the partial sum, a first output of the bit-serial multiplication through a first part circuit of the partial sum register;
determine whether not to clock-gate the second part circuit of the partial sum register or not based on a first feature bit of the partial sum; and
provide, based on the first feature bit of the partial sum, a second output of the bit-serial multiplication through the second part circuit of the partial sum register.

10. The partial sum register according to claim 9, comprising:
the first part circuit, configured to receive a first input of an input data inputted to the partial sum;
the second part circuit, configured to receive a second input of the input data; and
a control circuit, configured to release a clock-gating of the second part circuit based on the first feature bit.

11. The partial sum register according to claim 10, wherein the control circuit comprises:
a most significant bit monitoring circuit, configured to detect a negative edge of a most significant bit of the partial sum;
a feature bit monitoring circuit, configured to detect a positive edge or a negative edge of the first feature bit; and
a latch circuit, configured to provide a first gating signal for clock-gating the second part circuit.

12. The partial sum register according to claim 11, wherein the most significant bit monitoring circuit comprises:
a negative edge detector, configured to detect the negative edge of the most significant bit of the partial sum and to provide a most significant bit switch signal; and
a NOR gate, configured to receive the most significant bit switch signal and a reset bar signal and provide a reset latching signal to the latch circuit.

13. The partial sum register according to claim 11, wherein the feature bit monitoring circuit comprises:
a positive edge detector, configured to detect the positive edge of the first feature bit and to provide a positive trigger signal;
a negative edge detector, configured to detect the negative edge of the first feature bit and to provide a negative trigger signal; and
a multiplexer, configured to receive one of the positive trigger signal and the negative signal, to receive a logic low signal and the first gating signal, and to provide, based on the first gating signal, one of the positive trigger signal, the negative signal, and the logic low signal as a first latching signal to the latch circuit.

14. The partial sum register according to claim 11, wherein the latching circuit comprises:
a first SR latch, configured to receive a reset latching signal and a first latching signal and to provide the first gating signal.

15. The partial sum register according to claim 10, comprising:
a third part circuit, configured to receive a third input of the input data; and
a control circuit, configured to clock-gate or release a clock-gating of the third part circuit based on a second feature bit of the partial sum.

16. A computing method, comprising:
clock-gating a second part circuit of a partial sum register;
receiving a partial sum of a bit-serial multiplication of an input signal and a weight signal;
providing, based on the partial sum, a first output of the bit-serial multiplication through a first part circuit of the partial sum register;
determining whether not to clock-gate the second part circuit of the partial sum register or not based on a first feature bit of the partial sum; and
providing, based on the first feature bit of the partial sum, a second output of the bit-serial multiplication through the second part circuit of the partial sum register.

17. The computing method according to claim 16, wherein the first feature bit is a highest bit of the first part of the partial sum register.

18. The computing method according to claim 16, further comprising:
in response to a bit transition of the first feature bit, releasing a clock-gating of the second part of the partial sum register.

19. The computing method according to claim 18, further comprising:
representing the partial sum in a 2's complement form; and
in response to a most significant bit of the partial sum is 0, determining the bit transition of the first feature bit being switched from 0 to 1.

20. The computing method according to claim 18, further comprising:
representing the partial sum in a 2's complement form; and
in response to a most significant bit of the partial sum is 1, determining the bit transition of the first feature bit being switched from 1 to 0.
